(19) United States
(12) Patent Application Publication
(10) Pub. No.: US 2021/0247227 A1
(43) Pub. Date: Aug. 12, 2021

(54) PRODUCT WEIGHT CALCULATION SYSTEM

(71) Applicant: Ishida Co., Ltd., Kyoto (JP)

(72) Inventors: Takashi FURUKAWA, Ritto-shi (JP); Susumu KIMOTO, Ritto-shi (JP); Masahiro YAMAGUCHI, Ritto-shi (JP)

(73) Assignee: Ishida Co., Ltd., Kyoto (JP)

(21) Appl. No.: 17/159,673

(22) Filed: Jan. 27, 2021

(30) Foreign Application Priority Data
Feb. 10, 2020 (JP) 2020-021002

(51) Int. Cl. G01G 19/414; G01G 23/01; G01G 21/28

(52) U.S. Cl. CPC G01G 19/414; G01G 21/28; G01G 23/01

(57) ABSTRACT

A product weight calculation system includes an accommodation section, a door portion that switches between a closed state and an open state, a weight detector that detects a weight of the products accommodated in the accommodation section and outputs an output value, a door detector that detects a state of the door portion, and a product weight calculation unit that calculates a weight value of a product taken out from the accommodation section based on a difference between a first output value and a second output value when an output value of the weight detector decreases from the first output value and becomes the second output value in a case where it is determined from a detection result of the door detector that the door portion is transitioned from the open state to the closed state, and sets an output value after the calculation as a new first output value.

### TECHNICAL FIELD

An aspect of the present invention relates to a product weight calculation system.

### BACKGROUND

As a technology related to a product weight calculation system, for example, a purchased product registration device described in Japanese Unexamined Patent Publication No. H10-162244 has been known. The purchased product registration device described in Japanese Unexamined Patent Publication No. H10-162244 includes a product display section (accommodation section) that sorts and displays respective products by product, a plurality of measuring instruments (weight detectors) provided so that a total weight of products displayed in each product storage area of the product display section can be measured, and a controller that imports a weight measurement value of each measuring instrument and registers data of a customer-purchased product in a payment device based on a change in the weight measurement value. In the purchased product registration device described in Japanese Unexamined Patent Publication No. H10-162244, a weight measurement value of each measuring instrument is monitored on condition that identification data of a customer purchasing a product is input, and when it is detected that weight measurement data of any one measuring instrument has decreased, a decrease value thereof is calculated.

### SUMMARY

In the product weight calculation system described above, for example, when products are taken out from the accommodation section a plurality of times, errors included in a weight specified when the products are taken out and errors due to individual differences of the products are accumulated, and there is a possibility that a weight value of a product taken out from the accommodation section (hereinafter, also referred to as “taken-out product”) may not be correctly calculated.

Therefore, an object of an aspect of the invention is to provide a product weight calculation system capable of correctly calculating a weight value of a product taken out from an accommodation section.

A product weight calculation system according to an aspect of the invention includes an accommodation section that accommodates a plurality of products, a door portion that switches between a closed state that hinders the products from being taken in and out of the accommodation section and an open state that does not hinder the products from being taken in and out of the accommodation section, a weight detector that detects a weight of the products accommodated in the accommodation section and outputs an output value related to the weight of the products, a door detector that detects a state of the door portion, and a product weight calculation unit that calculates a weight value of a product taken out from the accommodation section based on a difference between a first output value and a second output value when an output value of the weight detector decreases from the first output value serving as a reference value and becomes the second output value in a case where it is determined from a detection result of the door detector that the door portion is transitioned from the open state to the closed state, and sets an output value output by the weight detector after the calculation as a new first output value.

In this product weight calculation system, the new first output value can be set each time the weight value of the product is calculated. Therefore, for example, even when products are taken out from the accommodation section a plurality of times, it is possible to suppress accumulation of errors included in a weight specified at the time of taking out and errors due to individual differences of the products. It is possible to correctly calculate the weight value of the taken-out product.

In the product weight calculation system according to the aspect of the invention, the weight detector may include an output unit that outputs the detected weight of the products as an analog value, a conversion unit that converts the analog value output by the output unit into a digital value, and an allocation unit that discretely allocates the digital value converted by the conversion unit to a weight value in a predetermined step size, and after the weight value of the products is calculated, the product weight calculation unit may offset a reference of the predetermined step size when the digital value is allocated to the weight value by the allocation unit so that the output value output by the weight detector becomes the new first output value. According to such a configuration, it is possible to specifically realize setting the output value output by the weight detector as the new first output value.

In the product weight calculation system according to the aspect of the invention, the weight detector may include an output unit that outputs the detected weight of the products as an analog value, a conversion unit that converts the analog value output by the output unit into a digital value, and an allocation unit that discretely allocates the digital value converted by the conversion unit to a weight value in a predetermined step size, the product weight calculation system further includes a calibration processing unit that executes a calibration process for calibrating the weight detector, and in the calibration process, in a case where the conversion unit converts a first analog value into a first digital value, when the analog value output by the output unit changes from the first analog value to a second analog value, and an amount of change per specified time is smaller than a predetermined range, the conversion unit may be calibrated so that the second analog value is converted into the first digital value.

From when a previous customer takes out a product from the accommodation section until a subsequent customer takes out a product from the accommodation section, even when an actual weight value of the products accommodated in the accommodation section does not fluctuate, for example, there is a possibility that the output value output by the weight detector may fluctuate (that is, an apparent output fluctuates) due to a creep phenomenon of the weight detector, etc. In this regard, according to the calibration processing unit, it is possible to suppress the apparent output fluctuation caused by the creep phenomenon, etc, and to correctly calculate the weight value of the taken-out product.

In the product weight calculation system according to the aspect of the invention, when it is determined from a detection result of the door detector that the door portion is in the open state, the calibration processing unit may execute the calibration process. In this case, it is possible to suppress apparent output fluctuation when the door portion is in the open state.

In the product weight calculation system according to the aspect of the invention, when it is determined from a detection result of the door detector that the door portion is in the closed state, the calibration processing unit may execute the calibration process. In this case, it is possible to suppress apparent output fluctuation when the door portion is in the closed state.

In the product weight calculation system according to the aspect of the invention, the calibration processing unit may execute the calibration process in a certain period. In this case, it is possible to reliably suppress the apparent output fluctuation.

In the product weight calculation system according to the aspect of the invention, the product weight calculation unit may determine the second output value after a predetermined time elapses from a timing when it is determined that the door portion has transitioned from the open state to the closed state, and calculate the weight value of the product taken out from the accommodation section. In this case, it is possible to suppress the adverse effect of vibration caused by opening and closing of the door portion on calculation of the weight value of the taken-out product.

In the product weight calculation system according to the aspect of the invention, the first output value may be 0. In this way, it is possible to suppress occurrence of logic errors.

The product weight calculation system according to the aspect of the invention may include one of the accommodation section, and one of the weight detector corresponding to the one of the accommodation section. In such a configuration, the weight value detected by the weight detector may have a particularly large accumulation of errors due to individual differences of the products. Therefore, in this case, the aspect of the invention that can correctly calculate the weight value of the taken-out product is particularly effective.

The product weight calculation system according to the aspect of the invention may include a plurality of the accommodation sections, and a plurality of the weight detectors corresponding to the plurality of the accommodation sections, respectively. In such a configuration, the overall structure of the system (tare, etc.) may tend to be large, and apparent output fluctuation due to the creep phenomenon, etc. may easily occur. Therefore, in this case, the aspect of the invention that can correctly calculate the weight value of the taken-out product is particularly effective.

The product weight calculation system according to the aspect of the invention may further include a number-of-products calculation unit that calculates the number of products taken out from the accommodation section based on the weight value of the products calculated by the product weight calculation unit and a weight value per product. In this case, as the weight value of the taken-out products can be correctly calculated, the number of the taken-out products can be correctly calculated.

A product weight calculation system according to an aspect of the invention includes an accommodation section that accommodates a plurality of products, a weight detector that detects a weight of the products accommodated in the accommodation section and outputs an output value related to the weight of the products, and a product weight calculation unit that calculates a weight value of a product taken out from the accommodation section based on a difference between a first output value and a second output value when an output value of the weight detector decreases from the first output value and becomes the second output value in a case where it is determined that an amount of change in an output value output by the weight detector per specified time with respect to the first output value serving as a reference value is larger than a predetermined range, and sets an output value output by the weight detector after the calculation as a new first output value.

In this product weight calculation system, the new first output value can be set each time the weight value of the product is calculated. Therefore, for example, even when products taken out from the accommodation section with opening and closing of the door portion a plurality of times, it is possible to suppress accumulation of errors included in a weight specified at the time of taking out and errors due to individual differences of the products. It is possible to correctly calculate the weight value of the taken-out product.

### BRIEF DESCRIPTION OF THE DRAWINGS

FIG. 1 is a schematic front view illustrating a product weight calculation system according to an embodiment.

FIG. 2 is a block diagram illustrating a configuration of the product weight calculation system of FIG. 1.

FIG. 3 is a flowchart illustrating an initial process.

FIG. 4 is a flowchart illustrating a calculation process for a taken-out product.

FIG. 5 is a flowchart illustrating a calibration process.

FIG. 6 is a diagram illustrating an example of temporal changes of a weight value measured by an electronic balance and an open/closed state of a door in the product weight calculation system.

FIG. 7A is a diagram for description of details of a process of setting a weight value currently measured by the electronic balance to 0. FIG. 7B is a diagram illustrating a continuation of FIG. 7A.

FIG. 8 is a diagram illustrating a continuation of FIG. 7B.

FIG. 9A is a diagram for description of details of the calibration process. FIG. 9B is a diagram illustrating a continuation of FIG. 9A.

### DETAILED DESCRIPTION

Hereinafter, an embodiment will be described in detail with reference to the drawings. In each figure, the same or corresponding parts are denoted by the same reference numerals, and duplicate description will be omitted. The terms “top” and “bottom” correspond to a top-bottom direction in a vertical direction.

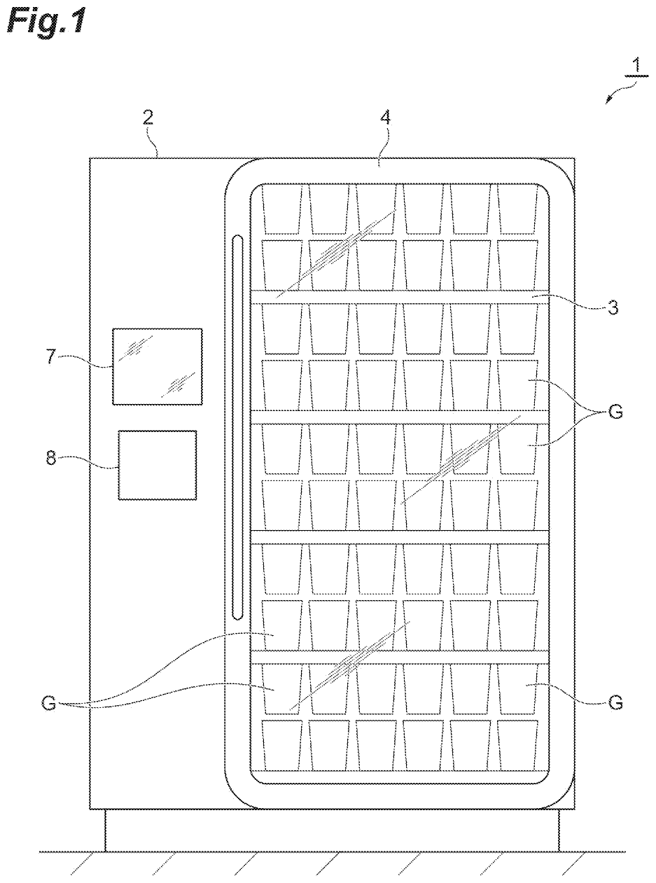

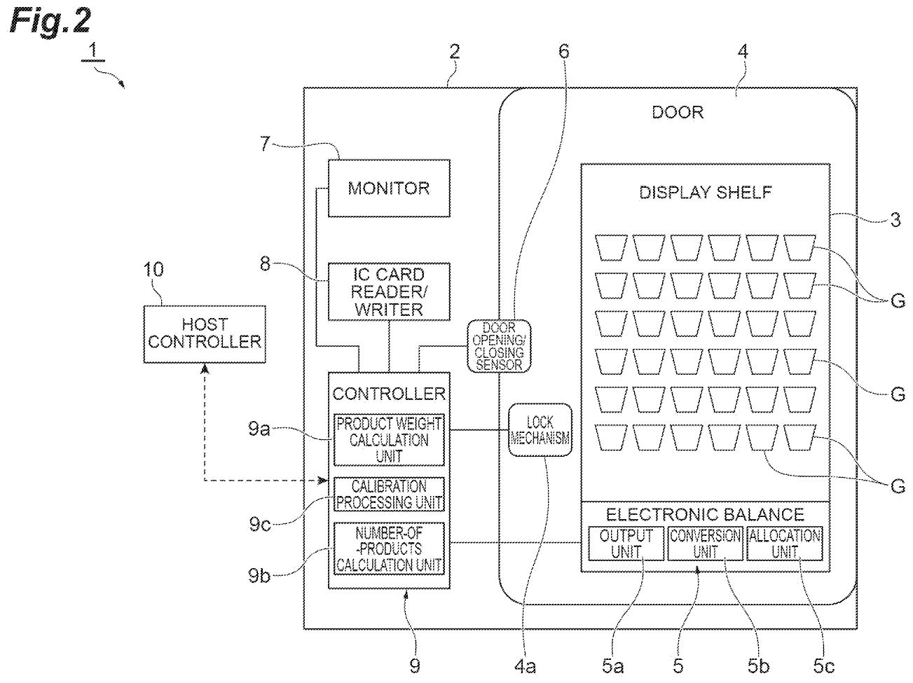

As illustrated in FIGS. 1 and 2, for example, a product weight calculation system 1 is a system used as a vending machine installed in a store, and includes a tare 2, a display shelf 3, a door 4, an electronic balance 5, a door opening/closing sensor 6, a monitor 7, an integrated circuit (IC) card reader/writer 8, and a controller 9.

The tare 2 is a structure that constitutes an appearance (outer circumference) of the product weight calculation system 1. The tare 2 has a shape of a rectangular box. The display shelf 3 is an accommodation section for accommodating a plurality of products G. The display shelf 3 displays the plurality of products G by placing or suspending the products G. One display shelf 3 is arranged in the tare 2. The display shelf 3 is provided so that the products G can be taken in and out from a front side. The products G are not particularly limited, and any articles may be applied. Examples of the products G include cup ramen. The plurality of products G may contain different types as long as the products G have the same weight.

The door 4 is a door portion that switches between a closed state that hinders the products G from being taken in and out of the display shelf 3 and an open state that does not hinder the products G from being taken in and out of the display shelf 3. For example, the door 4 is a single-door glass door disposed on the front side of the tare 2. The door 4 is not particularly limited, and various doors may be adopted. The door 4 has a lock mechanism 4a that can lock the door 4. When the lock mechanism 4a is locked, transition from the closed state to the open state of the door 4 is not allowed, and when the lock mechanism 4a is unlocked, transition from the closed state to the open state of the door 4 is allowed. The lock mechanism 4a is connected to the controller 9, and locking and unlocking are controlled by the controller 9.

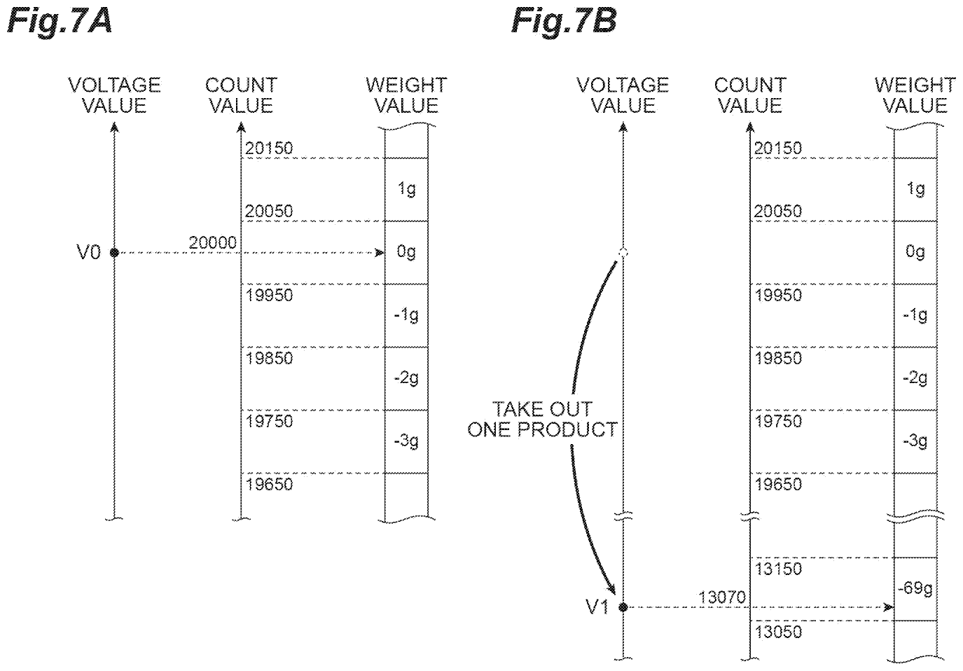

The electronic balance 5 is a weight detector that detects the weight of the products G accommodated in the display shelf 3 and outputs a weight value as an output value related to the weight of the products G. The electronic balance 5 electrically measures the weight value of the products G accommodated in the display shelf 3. One electronic balance 5 is provided and measures the entire display shelf 3. The electronic balance 5 is connected to the controller 9. The electronic balance 5 includes an output unit 5a that outputs the detected weight of the products G as a voltage value (analog value), a conversion unit 5b that converts the voltage value output by the output unit 5a into a count value (digital value), and an allocation unit 5c that discretely allocates the count value converted by the conversion unit 5b to the weight value in a predetermined step size (see FIG. 7A). The output unit 5a is, for example, a load cell. The load cell includes an element for measuring distortion of a semiconductor pressure sensor, etc. The conversion unit 5b performs A/D conversion (analog-digital conversion). The allocation unit 5c outputs the weight value obtained by allocation to the controller 9.

The door opening/closing sensor 6 is a door detector that detects a state of the door 4. The door opening/closing sensor 6 is connected to the controller 9. The door opening/closing sensor 6 detects whether the door 4 is in the closed state or the open state, and outputs a detection result to the controller 9. The door opening/closing sensor 6 is not particularly limited, and various sensors may be adopted.

The monitor 7 is a display unit that displays information to a user. The monitor 7 is connected to the controller 9. For example, based on a signal from the controller 9, the monitor 7 displays the number of the products G taken out from the display shelf 3 by the user (hereinafter, also referred to as “taken-out products G”), a charge, a balance of electronic money data in an IC card read by the IC card reader/writer 8, an amount of money obtained by subtracting the charge of the taken-out products G from the balance, the number of products G currently accommodated in the display shelf 3, etc.

The IC card reader/writer 8 is a device that performs reading and writing with respect to a non-contact type IC card. The IC card reader/writer 8 is connected to the controller 9. The IC card reader/writer 8 reads the electronic money data stored in the IC card and outputs the electronic money data to the controller 9. The IC card reader/writer 8 writes the electronic money data output from the controller 9 to the IC card.

For example, in the case of a plug-in type, the IC card reader/writer 8 outputs a card detection signal to the controller 9 when the IC card is inserted. Alternatively, for example, in the case of a placing type, the IC card reader/writer 8 outputs a card detection signal to the controller 9 when the IC card is placed and a take-out lock is activated. The controller 9 unlocks the lock mechanism 4a in response to the input of the card detection signal. The IC card reader/writer 8 returns the IC card or releases the take-out lock in response to a card return signal from the controller 9. The IC card reader/writer 8 is not particularly limited, and various reader/writers may be adopted. In the example here, the placing type reader/writer is used as the IC card reader/writer 8.

The controller 9 has a computer including a central processing unit (CPU), a read only memory (ROM), a random access memory (RAM), etc. The controller 9 can communicate with a host controller 10 wirelessly or by wire. Examples of the host controller 10 include at least one of a computer in a management center, a computer in the store, and a portable terminal such as a tablet computer. An input operation unit (not illustrated) that receives an input operation from the user and an administrator is connected to the controller 9.

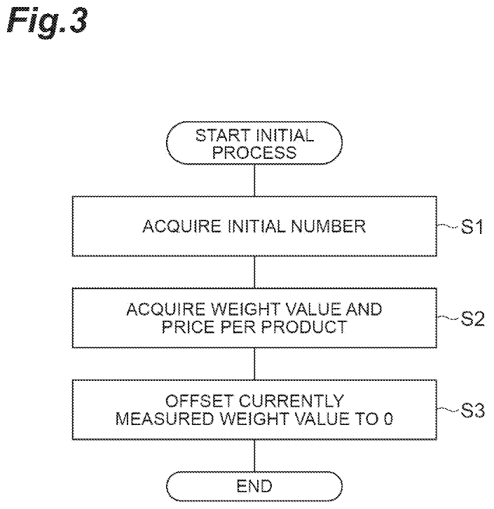

The controller 9 executes an initial process when, for example, the administrator performs an operation to execute the initial process via the input operation unit. As an example, as illustrated in FIG. 3, in the initial process, communication is performed with the host controller 10 to acquire the initial number of products G accommodated in the display shelf 3 (step S1). The initial number here is the number of products G accommodated in the display shelf 3 at the time of full load. Subsequently, communication is performed with the host controller 10 to acquire a weight value and a price per product G (step S2). Then, the weight value currently measured (output) by the electronic balance 5 is offset to 0 (first weight value) (step S3). That is, in step S3, the weight value output by the electronic balance 5 is set as a new first weight value (details will be described later). Note that in steps Si and S2, the initial number of products G, and the weight value and price per product G may be stored in advance in the controller 9, or may be acquired via the input operation unit. The steps S1 to S3 are in no particular order.

The controller 9 includes a product weight calculation unit 9a and a number-of-products calculation unit 9b as a functional configuration. In a case where it is determined from a detection result of the door opening/closing sensor 6 that the door 4 has transitioned from the open state to the closed state, when the weight value from the electronic balance 5 is reduced from 0 and becomes a weight value after taking out (second weight value), the product weight calculation unit 9a calculates a weight value of the taken-out products G taken out from the display shelf 3 based on a difference between 0 and the weight value after taking out. After the calculation, the product weight calculation unit 9a offsets the weight value currently measured by the electronic balance 5 to 0.

After a predetermined time elapses from the timing when it is determined from the detection result of the door opening/closing sensor 6 that the door 4 has transitioned from the open state to the closed state, the product weight calculation unit 9a determines the weight value after taking out and calculates the weight value of the taken-out products G. The predetermined time corresponds to a time required for vibration of the display shelf 3 due to opening and closing of the door 4 to naturally settle, and is not particularly limited. The predetermined time may be acquired by communication with the host controller 10, may be stored in the controller 9 in advance, or may be acquired via the input operation unit. The number-of-products calculation unit 9b calculates the number of taken-out products G based on the weight value of the taken-out products G calculated by the product weight calculation unit 9a and the weight value per product G.

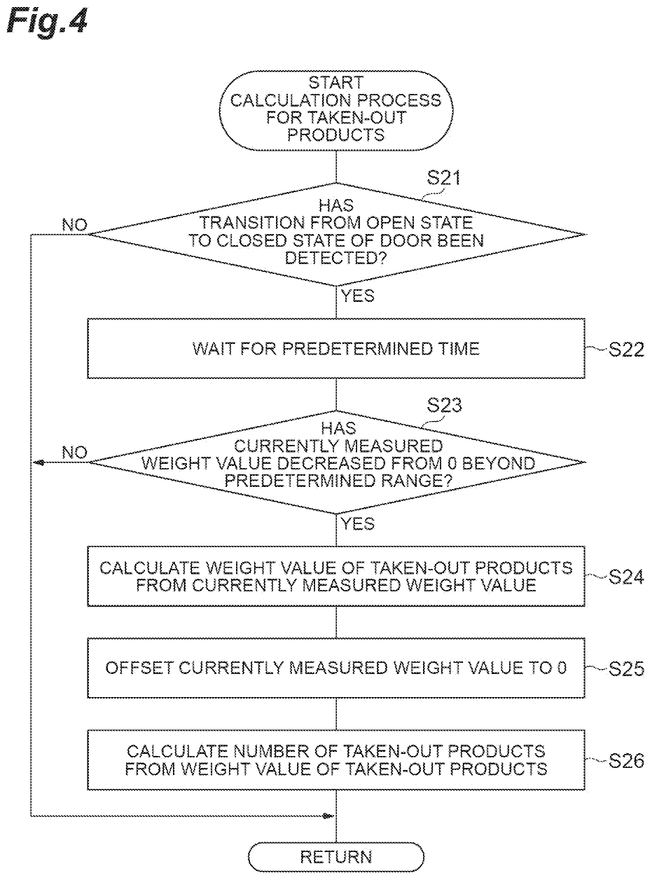

After the above-mentioned initial process, the product weight calculation unit 9a and the number-of-products calculation unit 9b repeatedly execute the calculation process for the taken-out products in a certain period. As an example, as illustrated in FIG. 4, in the calculation process for the taken-out products, it is determined from the detection result of the door opening/closing sensor 6 whether or not the door 4 has transitioned from the open state to the closed state (step S21). In the case of YES in step S21, a predetermined time is waited (step S22). It is determined whether or not the weight value currently measured by the electronic balance 5 has decreased beyond a predetermined range (step S23). In the case of YES in step S23, the weight value of the taken-out product G is calculated based on the weight value currently measured by the electronic balance 5 (step S24). In step S24, the weight value after taking out corresponding to a negative value is measured, and the absolute value of the weight value after taking out becomes the weight value of the taken-out products G. Subsequently, the weight value currently measured by the electronic balance 5 is offset to 0 (step S25). That is, in step S25, the weight value output by the electronic balance 5 is set as a new first weight value (details will be described later). From the weight value of the taken-out products G, the number of the taken-out products G is calculated (step S26).

In step S26, a value obtained by dividing the weight value of the taken-out products G calculated in step S24 by the weight value per product G is calculated as the number of taken-out products G. Further, in step S26, the number of products G currently accommodated in the display shelf 3 (inventory of the display shelf 3) is updated based on the number of taken-out products G. In the case of NO in step S21, in the case of NO in step S23, or after step S26, the process of this period is ended, and the process proceeds to step S21 of a subsequent cycle.

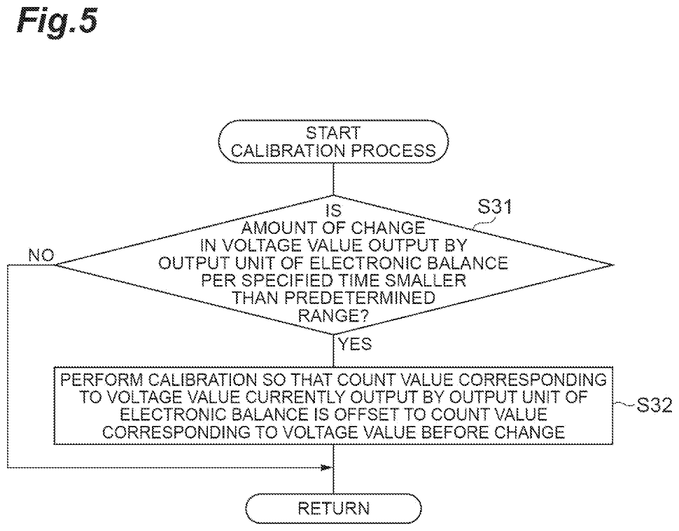

The controller 9 includes a calibration processing unit 9c that calibrates the electronic balance 5 as a functional calibration. After the above-mentioned initial process, the calibration processing unit 9c repeatedly executes a calibration process in a certain period. As an example, as illustrated in FIG. 5, in the calibration process, it is determined whether or not the amount of change in the voltage value output by the output unit 5a of the electronic balance 5 per specified time is smaller than a predetermined range (step S31). In the case of Yes in step S31, a reference voltage for AID conversion by the conversion unit 5b is calibrated so that a count value corresponding to the voltage value currently output by the output unit 5a is offset to a count value corresponding to the voltage value before the change (step S32). In other words, in step S32, the reference voltage for A/D conversion by the conversion unit 5b is offset so that the same count value is converted before and after the change in the voltage value. That is, in step S32, in a case where the conversion unit 5b converts a first voltage value (first analog value) into a first count value (first digital value), when the voltage value output by the output unit 5a changes from the first voltage value to the second voltage value (second analog value), and the amount of change per specified time is smaller than the predetermined range, the conversion unit 5b is calibrated so that the second voltage value is converted into the first count value (details will be described below). In the case of No in step S31, the process of this period is ended, and the process proceeds to step S31 of a subsequent period. The calibration process is also referred to as a tracking process. The specified time is a predetermined time. The predetermined range and the specified time are not particularly limited, and various ranges and times may be adopted.

When the number of taken-out products G is calculated, the controller 9 executes a settlement process. In the settlement process, the charge of the taken-out products G is determined based on a unit price of the taken-out products G (price per piece) and the number of the taken-out products G calculated by the number-of-products calculation unit 9b. In the settlement process, the determined charge of the taken-out products G is subtracted from the electronic money data read by the IC card reader/writer 8. In the settlement process, the electronic money data after subtraction is output to the IC card reader/writer 8.

When the card detection signal is input from the IC card reader/writer 8, the controller 9 unlocks the lock mechanism 4a of the door 4. When it is determined from the detection result of the door opening/closing sensor 6 that the door 4 is in the closed state, and the settlement process for the taken-out products G is ended, the controller 9 locks the lock mechanism 4a of the door 4 on the assumption that a purchase end condition is satisfied. When it is determined from the detection result of the door opening/closing sensor 6 that the door 4 is in the closed state, and a purchase cancellation operation is performed via the input operation unit, etc. (not illustrated) without the taken-out products G being detected (the number of taken-out products G is 0), the controller 9 locks the lock mechanism 4a of the door 4 on the assumption that the purchase end condition is satisfied. When the purchase end condition is satisfied, the controller 9 outputs a card return signal to the IC card reader/writer 8.

The controller 9 controls display of the monitor 7. The controller 9 causes the monitor 7 to display at least one of the results of the respective executed processes. The controller 9 causes the monitor 7 to display at least one of the calculated number of the taken-out products G, the charge, the balance of the electronic money data, the balance of the electronic money data after the settlement process, the number of products G currently accommodated in the display shelf 3, etc. The controller 9 transmits at least one of the results of the respective executed processes to the host controller 10. For example, the controller 9 transmits the inventory of the products G in the display shelf 3 to the host controller 10. For example, the controller 9 calculates the cumulative number (sales number) of the taken-out products G, and transmits the cumulative number of the taken-out products G to the host controller 10.

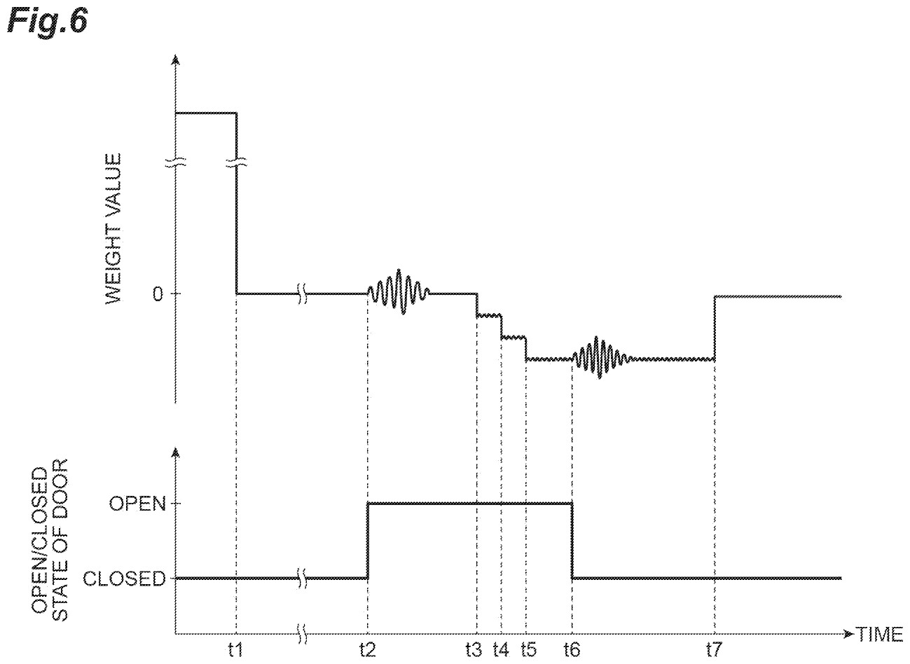

Next, a description will be given of an example of a case where the products G are taken out and purchased in the product weight calculation system 1 with reference to FIG. 6.

In the example illustrated in FIG. 6, in the product weight calculation system 1, the display shelf 3 is replenished until the display shelf 3 is fully loaded with the products G, the initial process is executed at time t1, and the currently measured weight value is offset to 0. In this instance, the door 4 is in the closed state. While the weight value is 0, the calibration process is executed, and when the amount of change in the voltage value output by the output unit 5a per specified time is smaller than the predetermined range, the amount of change is ignored.

In such a product weight calculation system 1, the user first places an IC card on the IC card reader/writer 8. In this way, the take-out lock is activated on the IC card reader/writer 8, and the IC card cannot be taken out from the IC card reader/writer 8. Further, the lock mechanism 4a of the door 4 is unlocked by the controller 9.

In the example illustrated in FIG. 6, the user opens the door 4 at time t2. The user takes out one product G at each of times t3, t4, and t5 to take out a total of three products. The user closes the door 4 at time t6. In this way, at time t7 when a predetermined time has elapsed from time t6, the weight value and the number of the taken-out products G are calculated by a calculation process for the taken-out products. The currently measured weight value is offset to 0. Here, immediately after time t6, the measured weight value vibrates due to vibration caused by transition of the door 4 from the open state to the closed state. However, at time t7, the vibration settles, and an adverse effect of the vibration on the calculation process for the taken-out products is avoided. Thereafter, the settlement process is executed. After the end of the settlement process, various types of information are displayed on the monitor 7, the lock mechanism 4a of the door 4 is locked, the take-out lock of the IC card from the IC card reader/writer 8 is released, and the process ends.

Next, a detailed description will be given of an example of a process of offsetting the weight value currently measured by the electronic balance 5 to 0 in the above-mentioned initial process and calculation process for the taken-out products.

For example, in the state illustrated in FIG. 7A, the output unit 5a outputs a voltage value of V0. The conversion unit 5b converts the voltage value of V0 and outputs a count value of 20,000. The allocation unit 5c allocates the count value of 20,000 to 0 g. The allocation unit 5c sets a predetermined step size of the count value to 100, and converts a weight value of 1 g for each count value of 100. Here, the allocation unit 5c allocates the count value of 20,000 so that the count value becomes a median of the predetermined step size, and a count value of 19,950 or more and less than 20,050 is allocated to 0 g.

When one product G is taken out from the display shelf 3, as illustrated in FIG. 7B, the voltage value from the output unit 5a decreases from V0 to V1. The conversion unit 5b converts a voltage value of V1 and outputs a count value of 13,070. The allocation unit 5c allocates the count value of 13,070 to −69 g. The electronic balance 5 outputs a weight value of −69 g as a post-taking out weight value (second output value). Here, since allocation to 0 g (weight value) is performed by the allocation unit 5c, calculation (specification) of the amount of change becomes easy when the weight value further changes from this value 0 g. Specifically, when the weight value changes from 0 g to −69 g, the weight of the product G taken out from the electronic balance 5 (display shelf 3) can be specified to be 69 g by performing a process of taking the absolute value of −69 g. For this reason, it is unnecessary to perform a more complicated process such as storing a weight value α before a weight change, acquiring a weight value β after the weight change, and subtracting the weight value β from the weight value α. Further, a time required for calculation can be shortened, the number of calculation steps can be reduced, and logic errors are less likely to occur.

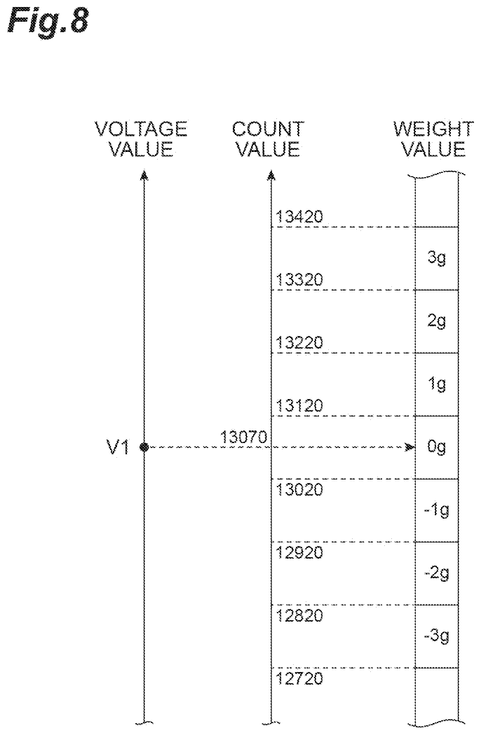

Then, after calculation of the weight value of the taken-out products G is completed, as illustrated in FIG. 8, a reference of the predetermined step size is offset when the count value is allocated to the weight value by the allocation unit 5c so that the currently measured weight value becomes 0. Specifically, the reference (conversion table) of the predetermined step size of the allocation unit 5c is shifted so that the count value of 13,070 currently output by the conversion unit 5b is allocated to 0 g. Here, the count value of 13,070 is allocated by the allocation unit 5c so that the count value becomes the median of the predetermined step size, and the count value of 13,020 or more and less than 13,120 is allocated to 0 g. In this way, in addition to allocating the count value to 0 g, which is the first output value, the currently output count value is allocated so that the count value becomes the median of the predetermined step size, and thus the effect of suppressing accumulation of errors described later becomes remarkable. Specifically, an error, which can occur when the currently output count value becomes a value larger or smaller than the median of the predetermined step size (biased value) and is not shifted, is reset. For this reason, subsequent calculation of the weight value becomes accurate. That is, it is possible to prevent an error included in the weight specified at the time of taking out (error due to the currently output count value being a value larger or smaller than the median of the predetermined step size (biased value)) from carrying over during subsequent calculation of the weight value and accumulating.

Next, a description will be given of an example of the above-mentioned calibration process.

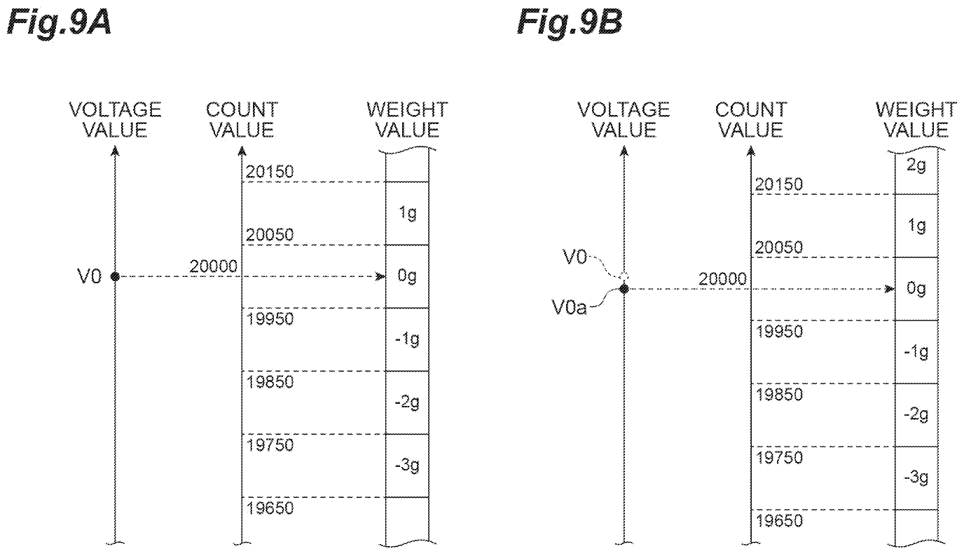

For example, in a state illustrated in FIG. 9A, the output unit 5a outputs the first voltage value of V0. The conversion unit 5b converts the first voltage value and outputs the first count value of 20,000. The allocation unit 5c allocates the first count value of 20,000 to 0 g.

As illustrated in FIG. 9B, within a specified time thereafter, the first voltage value of the output unit 5a is reduced (changed) to the second voltage value. The amount of change from the first voltage value to the second voltage value is smaller than a predetermined range. In this case, the conversion unit 5b is calibrated so that the second voltage value is converted into the first count value. As a result, the conversion unit 5b converts the voltage value of V0a and outputs a count value of 20,000. Note that in the calibration process, it is unnecessary to calibrate allocation by the allocation unit 5c, and the reference of the predetermined step size remains the same without offset.

An example of the calibration process is not limited to the above-mentioned process. For example, in the calibration process, when the voltage value changes by a change amount smaller than a predetermined range within a specified time, the change amount (difference between the first voltage value and the second voltage value) may be cumulatively held, and correction may be performed by subtracting the change amount from the voltage value output from the output unit 5a. In this case, the conversion unit 5b A/D coverts the voltage value after correction. The held change amount is cleared in step S3 or step S25.

As described above, in the product weight calculation system 1, the weight value measured by the electronic balance 5 can be set to 0 each time the weight value of the taken-out product G is calculated. Therefore, for example, even when the taken-out products G are taken out from the display shelf 3 a plurality of times, it is possible to suppress accumulation of errors included in the weight specified at the time of taking out and errors due to individual differences of the taken-out products G. It is possible to correctly calculate the weight value of the taken-out products G.

In the product weight calculation system 1, the electronic balance 5 includes the output unit 5a that outputs the detected weight of the products G as a voltage value, the conversion unit 5b that converts the voltage value output by the output unit 5a into a count value, and the allocation unit 5c that discretely allocates the count value converted by the conversion unit 5b to the weight value in a predetermined step size.

After the weight value of the products G is calculated, the product weight calculation unit 9a offsets the reference of the predetermined step size when the count value is allocated to the weight value by the allocation unit 5c so that the currently measured weight value becomes 0. According to such a configuration, it is possible to specifically realize setting the weight value measured by the electronic balance 5 to 0.

The product weight calculation system 1 includes the calibration processing unit 9c that executes the calibration process for calibrating the electronic balance 5. In the calibration process, in a case where the conversion unit 5b converts the first voltage value into the first count value, when the voltage value output by the output unit 5a changes from the first voltage value to the second voltage value, and the amount of change per specified time is smaller than a predetermined range, the conversion unit 5b is calibrated so that the second voltage value is converted into the first count value.

From when a previous customer takes out a product G from the display shelf 3 until a subsequent customer takes out a product G from the display shelf 3, even when an actual weight value of the products G accommodated in the display shelf 3 does not fluctuate, for example, there is a possibility that the weight value output by the electronic balance 5 may fluctuate (that is, an apparent weight fluctuates) due to a creep phenomenon of the electronic balance 5, etc. In this regard, according to the calibration processing unit 9c, it is possible to suppress the apparent weight fluctuation caused by the creep phenomenon, etc, and to correctly calculate the weight value of the taken-out products G.

In the product weight calculation system 1, the calibration processing unit 9c executes the calibration process in a certain period. In this way, apparent weight fluctuation can be reliably suppressed.

In the product weight calculation system 1, the product weight calculation unit 9a determines a post-taking out weight value after a predetermined time elapses (for example, time t7 of FIG. 6) from the timing when it is determined that the door 4 has transitioned from the open state to the closed state (for example, time t6 of FIG. 6), and calculates the weight value of the taken-out products G. In this way, it is possible to suppress the adverse effect of vibration caused by opening and closing of the door 4 on calculation of the weight value of the taken-out products G.

In the product weight calculation system 1, the first weight value, which is a reference value when calculating the weight value of the taken-out products S, is set to 0. In this way, it is possible to specifically realize correctly calculating the weight value of the taken-out products G by suppressing the apparent weight fluctuation. It is possible to suppress occurrence of logic errors. It is possible to suppress the complicated calculation process and increase the calculation speed. Note that the first weight value may be 0 (g), and is not limited to 0. The first weight value may be another value.

The product weight calculation system 1 includes one display shelf 3, and one electronic balance 5 corresponding to one display shelf 3. In such a configuration, the weight value measured by the electronic balance 5 may have a particularly large accumulation of errors due to individual differences of the products G. Therefore, in this case, the product weight calculation system 1 that can correctly calculate the weight value of the taken-out products G is particularly effective.

The product weight calculation system 1 calculates the number of taken-out products G by the number-of-products calculation unit 9b based on the weight value of the taken-out products G and the weight value per product G. In this case, as the weight value of the taken-out products G can be correctly calculated, the number of the taken-out products G can be correctly calculated.

Even though the embodiment has been described above, one aspect of the invention is not limited to the embodiment, and various modifications can be made without departing from the gist thereof.

In the embodiment, even after the settlement process is executed, for example, when the taken-out product G is returned to the display shelf 3 within a certain period of time, a return process may be executed by the controller 9. For example, in the return process, in a case where it is determined from the detection result of the door opening/closing sensor 6 that the door 4 has transitioned from the open state to the closed state, when the weight value detected by the door opening/closing sensor 6 increases from 0 and is a post-returning weight value (third weight value), the product weight calculation unit 9a calculates the weight value of the products G returned to the display shelf 3 based on a difference between 0 and the post-returning weight value. After the calculation, the product weight calculation unit 9a sets the weight value currently measured by the electronic balance 5 to 0. The number-of-products calculation unit 9b recalculates the number of taken-out products G based on the weight value of the products G returned to the display shelf 3 and the weight value per product G. After executing such a return process, the controller 9 cancels the executed settlement process and newly executes the settlement process based on the recalculated number of taken-out products G.

Note that the return process may be executed when it can be determined that a user returning the taken-out products G to the display shelf 3 is the same as a user taking out the taken-out products G based on an identification result of an identification unit of a camera, etc. In the return process, when items whose weight value per item is different from that of the products G are returned to the display shelf 3, a warning may be issued via, for example, the monitor 7. In the embodiment, when the balance of electronic money data in the IC card read by the IC card reader/writer 8 is less than a certain amount, the controller 9 may keep the lock mechanism 4a of the door 4 locked.

In the embodiment, the accommodation section is not limited to the display shelf 3, and various accommodation sections may be adopted. In the embodiment, the weight detector is not limited to the electronic balance 5, and various weight detectors may be adopted. In the embodiment, the medium for handling electronic money is not limited to the IC card, and various media may be adopted. In this case, instead of the IC card reader/writer 8, a device that performs reading and writing with respect to the medium may be provided.

In the embodiment, the calibration processing unit 9c may execute the calibration process when it is determined from the detection result of the door opening/closing sensor 6 that the door 4 is in the open state. In this case, it is possible to suppress apparent weight fluctuation when the door 4 is in the open state.

In the embodiment, the calibration processing unit 9c may execute the calibration process when it is determined from the detection result of the door opening/closing sensor 6 that the door 4 is in the closed state. In this case, it is possible to suppress apparent weight fluctuation when the door 4 is in the closed state.

In the embodiment, a plurality of display shelves 3 may be provided, and a plurality of electronic balances 5 may be provided corresponding to the plurality of display shelves 3, respectively. In such a configuration, the overall structure of the system (tare 2, etc.) may tend to be large, and apparent weight fluctuation due to the creep phenomenon, etc. may easily occur. Therefore, in this case, the product weight calculation system 1 that can correctly calculate the weight value of the taken-out products G is particularly effective.

In the embodiment, even though the weight value is adopted as the output value, the output value is not particularly limited and may be a value related to the weight of the products G. The output value may be a voltage value (analog value) or a count value (digital value). In the embodiment, the electronic balance 5 includes the conversion unit 5b and the allocation unit 5c. However, the controller 9 may have at least a part of the functions of the conversion unit 5b and the allocation unit 5c. In this case, the electronic balance 5 and the controller 9 are included in the weight detector.

In the embodiment, the product weight calculation system 1 may not include the door 4 and the door opening/closing sensor 6. In addition, in a case where it is determined that the amount of change per specified time in the weight value (output value) currently measured by the electronic balance 5 with respect to 0 is larger than a predetermined range, when the weight value decreases from 0 and becomes the post-taking out weight value, the product weight calculation unit 9a may calculate the weight value of the taken-out products G based on a difference between 0 and the post-taking out weight value, and offset the weight value currently measured by the electronic balance 5 to 0 after the calculation. In this case, when the weight measured by the electronic balance 5 rapidly changes due to, for example, separation of a product from the electronic balance 5, the product weight calculation system 1 calculates a weight value (change amount of the weight value) of the separated product. Even in this case, the various effects described above are obtained. For example, such a configuration is used when a customer sets aside a side dish from a plate on which the side dish is served and the customer purchases the set side dish (product) in a store. The plate on which the side dish is served is placed on the electronic balance 5. For example, the electronic balance 5 outputs a weight (reduced weight) of the set side dish to calculate a charge to be charged to the customer.

Various materials and shapes can be applied to the respective configurations in the above-described embodiment and modifications, without being limited to the above-mentioned materials and shapes. Each configuration in the above embodiment or modifications can be arbitrarily applied to each configuration in another embodiment or modification. A part of each configuration in the above-described embodiment or modifications can be appropriately omitted without departing from the gist of one aspect of the invention.

According to one aspect of the invention, it is possible to provide a product weight calculation system capable of correctly calculating a weight value of a product taken out from an accommodation section.

What is claimed is:

1. A product weight calculation system comprising:
an accommodation section that accommodates a plurality of products;
a door portion that switches between a closed state that hinders the products from being taken in and out of the accommodation section and an open state that does not hinder the products from being taken in and out of the accommodation section;
a weight detector that detects a weight of the products accommodated in the accommodation section and outputs an output value related to the weight of the products;
a door detector that detects a state of the door portion; and
a product weight calculation unit that calculates a weight value of a product taken out from the accommodation section based on a difference between a first output value and a second output value when an output value of the weight detector decreases from the first output value serving as a reference value and becomes the second output value in a case where it is determined from a detection result of the door detector that the door portion is transitioned from the open state to the closed state, and sets an output value output by the weight detector after the calculation as a new first output value.

2. The product weight calculation system according to claim 1,
wherein the weight detector includes
an output unit that outputs the detected weight of the products as an analog value,
a conversion unit that converts the analog value output by the output unit into a digital value, and
an allocation unit that discretely allocates the digital value converted by the conversion unit to a weight value in a predetermined step size, and
after the weight value of the products is calculated, the product weight calculation unit offsets a reference of the predetermined step size when the digital value is allocated to the weight value by the allocation unit so that the output value output by the weight detector becomes the new first output value.

3. The product weight calculation system according to claim 1,
wherein the weight detector includes
an output unit that outputs the detected weight of the products as an analog value,
a conversion unit that converts the analog value output by the output unit into a digital value, and
an allocation unit that discretely allocates the digital value converted by the conversion unit to a weight value in a predetermined step size,
the product weight calculation system further comprises
a calibration processing unit that executes a calibration process for calibrating the weight detector, and
in the calibration process,
in a case where the conversion unit converts a first analog value into a first digital value, when the analog value output by the output unit changes from the first analog value to a second analog value, and an amount of change per specified time is smaller than a predetermined range, the conversion unit is calibrated so that the second analog value is converted into the first digital value.

4. The product weight calculation system according to claim 3, wherein when it is determined from a detection result of the door detector that the door portion is in the open state, the calibration processing unit executes the calibration process.

5. The product weight calculation system according to claim 3, wherein when it is determined from a detection result of the door detector that the door portion is in the closed state, the calibration processing unit executes the calibration process.

6. The product weight calculation system according to claim 3, wherein the calibration processing unit executes the calibration process in a certain period.

7. The product weight calculation system according to claim 1, wherein the product weight calculation unit determines the second output value after a predetermined time elapses from a timing when it is determined that the door portion has transitioned from the open state to the closed state, and calculates the weight value of the product taken out from the accommodation section.

8. The product weight calculation system according to claim 1, wherein the first output value is 0.

9. The product weight calculation system according to claim 1, comprising:
one of the accommodation section; and
one of the weight detector corresponding to the one of the accommodation section.

10. The product weight calculation system according to claim 1, comprising:
a plurality of the accommodation sections; and
a plurality of the weight detectors corresponding to the plurality of the accommodation sections, respectively.

11. The product weight calculation system according to claim 1, further comprising
a number-of-products calculation unit that calculates the number of products taken out from the accommodation section based on the weight value of the products calculated by the product weight calculation unit and a weight value per product.

12. A product weight calculation system comprising:
an accommodation section that accommodates a plurality of products;
a weight detector that detects a weight of the products accommodated in the accommodation section and outputs an output value related to the weight of the products; and
a product weight calculation unit that calculates a weight value of a product taken out from the accommodation section based on a difference between a first output value and a second output value when an output value of the weight detector decreases from the first output value and becomes the second output value in a case where it is determined that an amount of change in an output value output by the weight detector per specified time with respect to the first output value serving as a reference value is larger than a predetermined range, and sets an output value output by the weight detector after the calculation as a new first output value.
